(19) United States
(12) Patent Application Publication
(10) Pub. No.: US 2025/0310258 A1
(43) Pub. Date: Oct. 2, 2025

(54) METHOD AND DEVICE FOR NEXT-GENERATION MOBILE COMMUNICATION SYSTEM COMBINED WITH COMPUTING IN NETWORK EQUIPMENT

(71) Applicant: Samsung Electronics Co., Ltd., Suwon-si, Gyeonggi-do (KR)

(72) Inventors: Dongmyung KIM, Suwon-si (KR); Sunhyun KIM, Suwon-si (KR); Jungsoo JUNG, Suwon-si (KR); Jiyoung CHA, Suwon-si (KR); Jinho CHOI, Suwon-si (KR)

(21) Appl. No.: 18/866,322

(22) PCT Filed: May 17, 2023
(86) PCT No.: PCT/KR2023/006667

§ 371 Date: Nov. 15, 2024

(30) Foreign Application Priority Data
May 19, 2022 (KR) 10-2022-0061637

(51) Int. Cl. H04L 45/76; H04L 41/40; H04L 41/5003

(52) U.S. Cl. CPC H04L 45/76; H04L 41/40; H04L 41/5003

(57) ABSTRACT

The present disclosure relates to a method performed by a first network entity on a control plane in a mobile communication system. The method comprises the steps of: transmitting a first message requesting in-network computing (INC)-capable information for a plurality of devices on a data transmission path; receiving, on the basis of the first message, a second message including the capable information for the plurality of devices; determining, on the basis of the second message, one or more target devices on which in-network computing is to be performed, from among the plurality of devices; and assigning in-network computing tasks to the one or more target devices, respectively.

### TECHNICAL FIELD

The disclosure relates to a method performed in a mobile communication system and, more particularly, to an in-network computing technology.

### BACKGROUND ART

A review of the development of wireless communication from generation to generation shows that the development has mostly been directed to technologies for services targeting humans, such as voice-based services, multimedia services, and data services. It is expected that connected devices which are exponentially increasing after commercialization of 5th generation (5G) communication systems will be connected to communication networks. Examples of things connected to networks may include vehicles, robots, drones, home appliances, displays, smart sensors installed in various infrastructures, construction machines, factory equipment, and the like. Mobiles devices are expected to evolve into various formfactors such as augmented reality glasses, virtual reality headsets, and hologram devices. In order to provide various services by connecting hundreds of billions of devices and things in the 6G era, there have been ongoing efforts to develop improved 6G communication systems. For these reasons, 6G communication systems are referred to as “beyond-5G” systems.

6G communication systems, which are expected to be implemented approximately by 2030, will have a maximum transmission rate of tera (1,000 giga)-level bps and a radio latency of 100μ sec. That is, 6G communication systems will be 50 times as fast as 5G communication systems and have the 1/10 radio latency thereof.

In order to accomplish such a high data transmission rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, a technology capable of securing the signal transmission distance (that is, coverage) will become more crucial. It is necessary to develop, as major technologies for securing the coverage, multiantenna transmission technologies including radio frequency (RF) elements, antennas, novel waveforms having a better coverage than OFDM, beamforming and massive MIMO, full dimensional MIMO (FD-MIMO), array antennas, and large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the frequency efficiencies and system networks, the following technologies have been developed for 6G communication systems: a full-duplex technology for enabling an uplink (UE transmission) and a downlink (node B transmission) to simultaneously use the same frequency resource at the same time; a network technology for utilizing satellites, high-altitude platform stations (HAPS), and the like in an integrated manner; a network structure innovation technology for supporting mobile nodes B and the like and enabling network operation optimization and automation and the like; a dynamic spectrum sharing technology though collision avoidance based on spectrum use prediction, an artificial intelligence (AI)-based communication technology for implementing system optimization by using AI from the technology design step and internalizing end-to-end AI support functions; and a next-generation distributed computing technology for implementing a service having a complexity that exceeds the limit of UE computing ability by using super-high-performance communication and computing resources (mobile edge computing (MEC), clouds, and the like). In addition, attempts have been continuously made to further enhance connectivity between devices, further optimize networks, promote software implementation of network entities, and increase the openness of wireless communication through design of new protocols to be used in 6G communication systems, development of mechanisms for implementation of hardware-based security environments and secure use of data, and development of technologies for privacy maintenance methods.

It is expected that such research and development of 6G communication systems will enable the next hyper-connected experience in new dimensions through the hyper-connectivity of 6G communication systems that covers both connections between things and connections between humans and things. Specifically, it is expected that services such as truly immersive XR, high-fidelity mobile holograms, and digital replicas could be provided through 6G communication systems. In addition, with enhanced security and reliability, services such as remote surgery, industrial automation, and emergency response will be provided through 6G communication systems, and thus these services will be applied to various fields including industrial, medical, automobile, and home appliance fields.

### DISCLOSURE

### Technical Problem

The disclosure provides a method of efficiently controlling and managing performance of in-network computing in network devices located in a data transmission path in a communication system (e.g., a 6G network) structure combined with in-network computing.

The disclosure provides an apparatus for identifying in-network computing resources for network devices in a data flow path and performing in-network computing, and a method of determining tasks.

Further, the disclosure provides a method of allocating tasks to devices to perform in-network computing.

In addition, the disclosure provides a method of monitoring in-network computing performed in network devices and optimizing an in-network computing operation, based on the monitoring.

### Technical Solution

A method performed by a first network entity in a control plane in a mobile communication system according to an embodiment of the disclosure includes transmitting a first message making a request for in-network computing (INC) capability information of a plurality of devices in a data transmission path to a second network entity, receiving a second message including capability information of the plurality of devices from a third network entity, based on the first message, determining one or more target devices to perform in-network computing among the plurality of devices, based on the second message, and allocating in-network computing tasks to each of the one or more target devices.

The method according to an embodiment of the disclosure may further include transmitting information on allocation of the in-network computing tasks, receiving a report on a result related to performance of the in-network computing tasks by each of the one or more target devices, based on the information on allocation of the tasks, and updating quality of service (QOS) parameters, based on the report.

The method according to an embodiment of the disclosure may further include monitoring the one or more target devices, detecting a change in the data transmission path, and retransmitting the first message making a request for in-network computing capability information of a plurality of devices in a changed path to the second network entity.

A first network entity in a control plane in a mobile communication system according to an embodiment of the disclosure may include a transceiver and a controller. The transceiver is configured to transmit a first message making a request for in-network computing (INC) capability information of a plurality of devices in a data transmission path to a second network entity and receive a second message including capability information of the plurality of devices from a third network entity, based on the first message. The controller is configured to determine one or more target devices to perform in-network computing among the plurality of devices, based on the second message and allocate in-network computing tasks to each of the one or more target devices.

### Advantageous Effects

According to an embodiment of the disclosure, it is possible to manage a plurality of network devices by controlling in-network computing through in-band signaling, based on a path in which actual data flow is transmitted, to control in-network computing to be optimized for a dynamically varying path environment, and to reduce signaling overhead required for the control.

According to an embodiment of the disclosure, it is possible to control and manage in-network computing of network devices in a path through a network function alone in a communication system (e.g., 5G or 6G) supported by the 3rd Generation Partnership Project (3GPP) without any control by a software-defined networking (SDN) controller.

According to an embodiment of the disclosure, it is possible to improve an application processing speed and efficiently use computing resources.

The technical subjects pursued in the disclosure may not be limited to the above-mentioned technical subjects, and other technical subjects which are not mentioned may be clearly understood from the following descriptions by those skilled in the art to which the disclosure pertains.

### DESCRIPTION OF DRAWINGS

FIG. 1 illustrates an example of a 5G network structure according to an embodiment of the disclosure.

FIG. 2 illustrates an example of a structure in which the 5G network structure is combined with an independent software-defined networking (SDN) controller/transport controller.

FIG. 3 illustrates an example of an in-network computing control structure using out-of-band signaling according to an embodiment of the disclosure.

FIG. 4 illustrates an example of a process for identifying resources for network devices in a path and determining tasks by using in-band signaling according to an embodiment of the disclosure.

FIG. 5 illustrates an example of a signaling flowchart illustrating an in-network computing control procedure using in-band signaling according to an embodiment of the disclosure.

FIG. 6 illustrates an example of the operation and structure for allocating tasks to network devices in a path by using in-band signaling according to an embodiment of the disclosure.

FIG. 7 illustrates an example of a process for monitoring the present status of data flow in which in-network computing is being performed using in-band signaling and optimizing an in-network computing operation, based on the monitoring according to an embodiment of the disclosure.

FIG. 8 illustrates an example of an operation procedure performed by a first network entity in a control plane in a mobile communication system according to an embodiment of the disclosure.

FIG. 9 is a block diagram illustrating a UE according to various embodiments of the disclosure.

FIG. 10 is a block diagram of a network entity according to various embodiments of the disclosure.

### MODE FOR INVENTION

Hereinafter, various embodiments of the disclosure will be described in detail in conjunction with the accompanying drawings. Furthermore, in describing embodiments of the disclosure, a detailed description of known functions or configurations incorporated herein will be omitted when it is determined that the description may make the subject matter of the embodiments unnecessarily unclear. The terms which will be described below are terms defined in consideration of the functions in the disclosure, and may be different according to users, intentions of the users, or customs. Therefore, the definitions of the terms should be made based on the contents throughout the specification.

For the same reason, in the accompanying drawings, some elements may be exaggerated, omitted, or schematically illustrated. Furthermore, the size of each element does not completely reflect the actual size. In the respective drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in various embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card.

In the following description, a base station is an entity that allocates resources to terminals, and may be at least one of an eNode B (eNB), a Node B, a base station (BS), a radio access network (RAN), an access network (AN), a RAN node, a NR NB, a gNB, a wireless access unit, a base station controller, and a node on a network. A terminal may include a user equipment (UE), a mobile station (MS), a cellular phone, a smartphone, a computer, or a multimedia system capable of performing a communication function. In various embodiments of the disclosure, the case where the terminal is a UE will be described by way of example.

Furthermore, in the following description of various embodiments, systems based on LTE, LTE-A, NR, or 6G may be described by way of example, but various embodiments of the disclosure may also be applied to other communication systems having similar technical backgrounds or channel types. In addition, based on determinations by those skilled in the art, the disclosure may also be applied to other communication systems through some modifications without significantly departing from the scope of the disclosure.

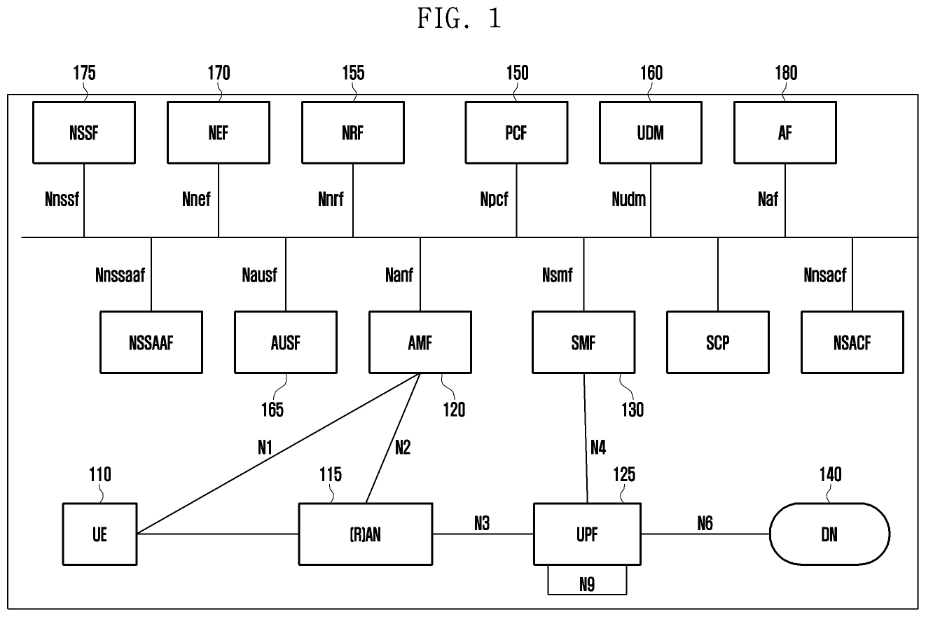

FIG. 1 illustrates an example of a 5G network structure according to an embodiment of the disclosure.

Referring to FIG. 1, respective functions provided by a 5G network system may be performed in units of network functions (NFs). Specifically, a 5G network may include at least one of an access and mobility management function (AMF) 120 that manages network access and mobility of a UE 110, a session management function (SMF) 130 that performs functions related to a session for the UE 110, a user plane function (UPF) 125 that serves to transmit user data and is controlled by the SMF 130, an application function (AF) 180 that communicates with a 5GC to provide an application service, a network exposure function (NEF) 170 that supports communication with the AF 180, a unified data management (UDM) 160 and a unified data repository (not shown) for storing and managing data, a policy and control function (PCF) 150 that manages a policy, or a data network (DN) 140 (for example, Internet) to which user data is transmitted.

In addition to the above NFs, an OAM (operation, administration, and management) server (not shown) corresponding to a system for managing the UE 110 and the 5G communication network may exist. Further, the 5G network may further include at least one of a RAN (for example, BS) 115, an authentication server function (AUSF) 165, a network slice selection function (NSSF) 175, or a network repository function (NRF) 155.

A mobile communication system such as the 5G network serves as a transmission tunnel that provide seamless connectivity of the Internet and a data network to UEs (users) having mobility for wireless access.

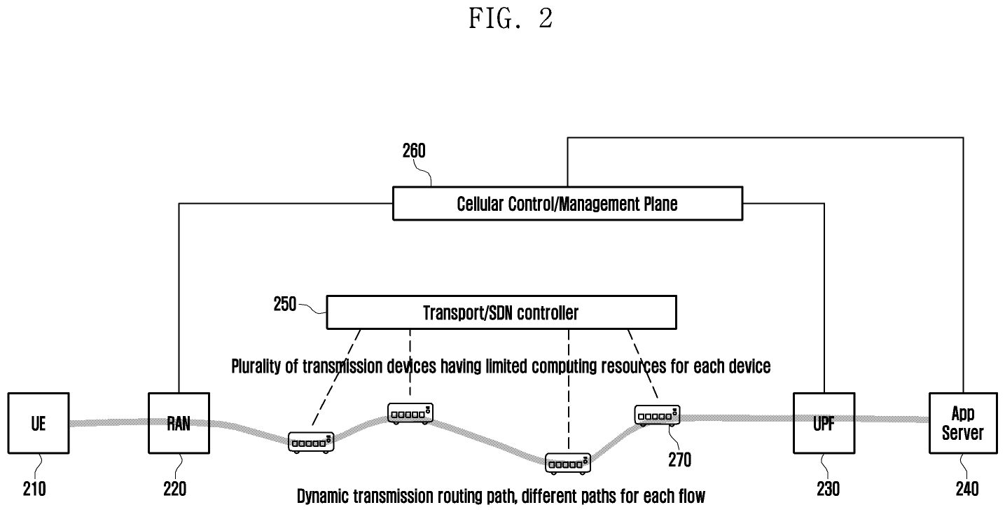

FIG. 2 illustrates an example of a structure in which the 5G network structure is combined with an independent software-defined networking (SDN) controller/transport controller.

Referring to FIG. 2, basically, a communication connection tunnel between a data network (DN) and a UE (user) is provided through a data communication path connected between the UE 210 and a RAN 220, and a UPF 230. One or more network devices 270 may be located in a data communication path between the RAN 220 and the UPF 230. A SDN controller/transport controller 250 may control each network device 270. A network entity 260 on a control plane of the 5G network may communicate with the RAN 220 or the UPF 230. Calculations and processing of an actual application may be performed by only the UE and an application layer of an application server 240 located within a DN.

As illustrated in FIG. 2, the structure in which a mobile communication system serves as only a data transmission path and only an application layer at each end performs application processing has been used up to recently, and the structure may satisfy most application requirements.

However, an amount of data required by applications, low-latency requirements, and the like are continuously increasing, and it may be difficult for the mobile communication system to meet the increasing amount of data and low-latency requirements simply by connecting all data traffic between end-to-end targets to perform the application.

With the development of the mobile communication system, a data center network technology for the connection between the server and other systems within the data center is also developing rapidly along with the introduction of cloud computing. In the disclosure, the data center may be a pool of mutually connected resources (computing, storage, and network) using a communication network. Further, the data center may be a network system that provides a server, a network line, and the like, and a plurality of servers may be included in the data center. A data center of a communication operator may be referred to as an Internet data center (IDC) or a cloud data center. A data center network also connects data center resources and thus plays an important role in the data center.

Recently, as a structure specialized to provide high-performance computing (HPC) by the data center, an in-network computing (INC) technology in which a network device accessorily accomplishes application layer's purpose by using programmability of the network device is researched and applied.

In-network computing is a technology through which network devices in a path perform some tasks of the application layer and may be expressed as on-path computing. In the in-network computing, computing may be performed by network devices in a packet transmission path, and thus effects of reducing delay and reducing data capacity may be expected. Further, compared to the general CPU, an advantage such as a fast processing speed and energy/cost efficiency may be expected. Since a range of calculations that network devices in a path can perform is expanding and data in a specific type (for example, AI interference, training, streaming, and the like) is explosively increasing, the technology such as in-network computing is increasingly in demand.

Computing hardware is evolving to a type in which heterogeneous modules are combined, a programmable network devices are increasing, and the feasibility of in-network computing is increasing due to the introduction of P4 language. Further, the possibility of performing specific application calculations even by a network/transport layer which conventionally served as only a data path is increasing. However, in consideration of absence of technical elements that can combine data centers and mobile communication systems having different application environment, requirements, and the like for in-network computing technology, the standard structure of the current mobile communication system including functions and structures that make it difficult to utilize the ability to perform application calculations of a network/transport layer, and functions and structures of commercial products, the application is not easy.

Hereinafter, the disclosure proposes a method of efficiently controlling and managing the performance of in-network computing by network devices located in a data transmission path in a mobile communication system (e.g., 5G or 6G network) structure and devices for the same.

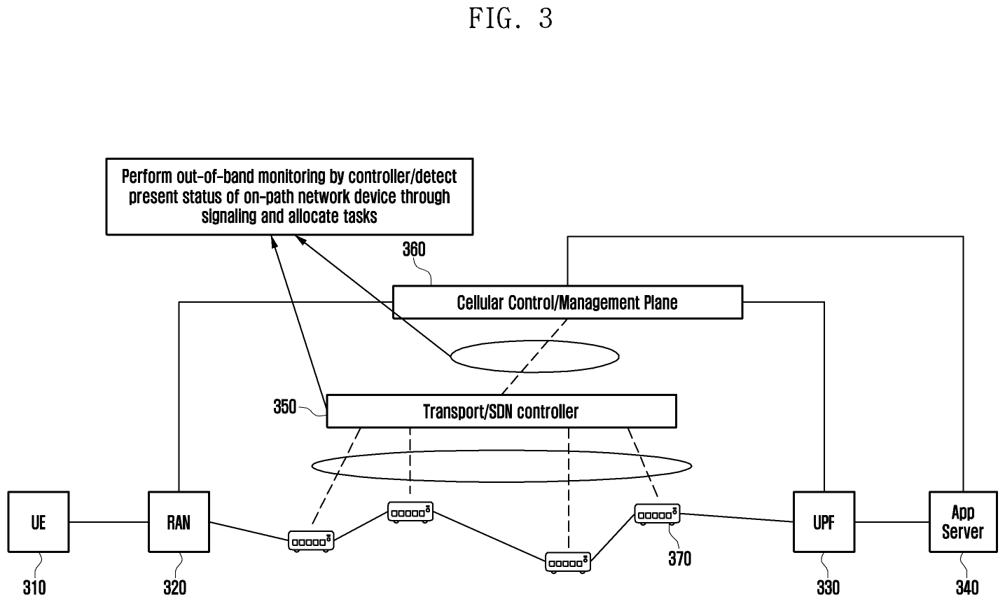

FIG. 3 illustrates an example of an in-network computing control structure using out-of-band signaling according to an embodiment of the disclosure.

In the disclosure, “out-of-band signaling” may mean a control scheme through a control plane path and an interface separately connected for the control purpose rather than a user plane path in which a data packet is transmitted. For example, “out-of-band signaling” may include all of signaling generated or controlled by a mobile communication network (or a network entity of the mobile communication network) and signaling generated or controlled by a device other than the mobile communication network entity. For example, “out-of-band signaling” may also include a scheme of transmitting and receiving a signal/channel for controlling in-network computing through a device (e.g., a SDN controller) other than the mobile communication network entity.

Referring to FIG. 3, basically, a communication connection tunnel between a DN including an application server 340 and a UE is provided through a data communication path connected between a UE 310, a RAN 320, and a UPF 330. Network devices 370 in the data communication path between the RAN 320 and the UPF 330 may be controlled by a transport/SDN controller 350. A network entity 360 in a control plane of the mobile communication network may acquire information on the network devices 370 through the transport/SDN controller 350.

Specifically, the transport/SDN controller 350 configured to control the network devices 370 may acquire information resource states for the network devices through separate out-of-band signaling (or interface) in a centralized manner. For example, the transport/SDN controller may collect information on all network devices in the path and transfer the corresponding information to the network entity 360 in the control plane. In another example, the transport/SDN controller may receive a request message that makes a request for resource state information of a specific device among the network devices in the path from the network entity 360 in the control plane. For example, the request message may be configured for each UE or each application. The transport/SDN controller may transfer the requested resource state information of the network device or the like to the network entity 360 in the control plane.

The network entity 360 in the control plane may identify calculations of each network device/a resource state of the memory or the like, based on information received from the transport/SDN controller. Further, the network entity 360 in the control plane may allocate tasks to network devices in the path so that the corresponding network devices can perform computing. Information on the allocated tasks may be transferred to each network device by out-of-band signaling (or interface) through the transport/SDN controller 350. That is, the network entity 360 in the control plane may transfer the information on the allocated tasks to the transport/SDN controller 350, and the transport/SDN controller 350 may transfer the corresponding information to the network device in the path.

However, in the case of out-of-band signaling described in FIG. 3, there may be much overhead to manage resource states of a plurality of network devices in the path and it may be difficult to grasp various pieces of information dynamically varying in the transmission path. Further, there is a disadvantage in that close interworking between the control plane of the mobile communication network and the transport/SDN controller is needed.

Hereinafter, the disclosure proposes a method of supporting in-network computing for a network device through in-band signaling by interworking a control plane and a network function (NF) of a data transport layer (that is, a user plane) in a communication system (e.g., 5G, 6G, or the like) supported in the 3GPP. In the disclosure, “in-band signaling” may mean a scheme of transmitting control information through a user plane path in which a data packet is transmitted. In-band signaling may include a scheme of generating and transmitting a separate packet for the purpose of control and a scheme of additionally inserting control information into the existing transmitted data packet and transmitting the data packet. Further, “in-band signaling” may be expressed as on-path signaling.

Specifically, a first embodiment proposes a method of identifying in-network computing resources for network devices in a data flow path and determining a device and tasks to perform in-network computing. A second embodiment proposes a method of allocating tasks to the device determined according to the first embodiment. A third embodiment proposes a method of monitoring in-network computing performed by the network device according to the first embodiment and the second embodiment and optimizing an in-network computing operation, based on the monitoring.

In description of an embodiment of the disclosure, the following terms may be used for convenience of description. However, the use of the terms does not limit the scope of the disclosure.

In the disclosure, a first network entity may be a network entity or a network function located in a control plane in a mobile communication system (e.g., 5G, 6G, beyond 6G, or the like). For example, the first network entity may include at least one of a SMF, a PCF, or an AMF.

In the disclosure, a second network entity may be a network entity or a network function located in a user plane in a mobile communication system (e.g., 5G, 6G, beyond 6G, or the like). For example, the second network entity may include a UPF.

In the disclosure, a network device existing in a communication path between the UE or the RAN and the data network may include a switch, a programmable switch (a switch having an operation that is not fixed within the switch and capable of programming and performing non-fixed calculations), a switch ASIC, a smart network interface card (NIC), a programmable NIC, a NF, a router, a FPGA, and the like, and may include all virtual network devices constituted by a physical network device and software.

In the disclosure, “computing resources” are resources for computing, and may mean various resources used for computing, such as a central processing unit (CPI), a graphics processing unit (GPU), an ASIC, a FPGA, a smart NIC, a storage space like a memory, a data transmission and reception device, a bandwidth of an interface inside or outside the device, and the like. For example, as a unit used for defining computing resources, the number of cores, flops (the number of floating point operations per second), or the like may be used.

### FIRST EMBODIMENT

The first embodiment proposes a method of identifying in-network computing resources for network devices in a data flow path and determining a device and tasks to perform in-network computing.

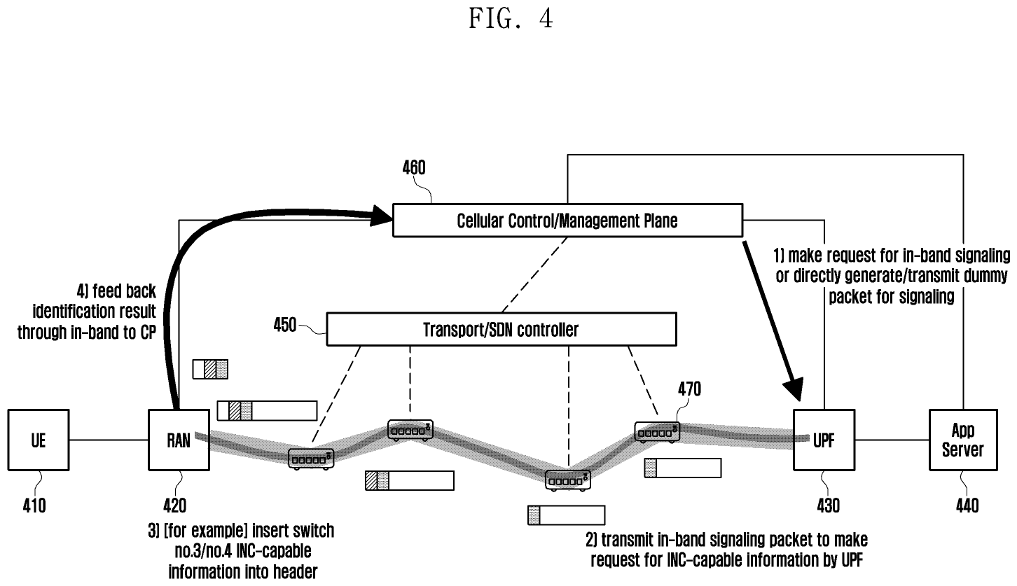

FIG. 4 illustrates an example of a process for identifying resources for network devices in a path and determining tasks by using in-band signaling according to an embodiment of the disclosure.

In FIG. 4, it is basically assumed that a communication connection tunnel between a DN including an application server 440 and a UE is provided through a data communication path connected between a UE 410 and a RAN 420, and a UPF 430. The UPF 430 may correspond to a second network entity in a user plane. Further, it is assumed that one or more network devices 470 are located in the data communication path between the RAN and the UPF. In the following description, a path may be a data communication path between the RAN and the UPF, or a path/tunnel in which data or a data packet is transmitted.

Referring to FIG. 4, in a mobile communication system, a first network entity 460 in a control plane may transmit information that makes a request for reporting in-network computing capability and available calculations/memory resource situation of network devices in a path to a second network entity (e.g., the UPF) in the user plane.

For example, the first network entity may directly generate a separate dummy data packet for the purpose of making a request for reporting the in-network computing capability and available calculations/memory resource situation, and transmit the same to the second network entity. The dummy data packet may include a UE reception address. The dummy data packet may be transferred to each network device through a data transmission tunnel configured between the UPF and the RAN.

In another example, the first network entity may transmit request information that makes a request for reporting in-network computing capability and current available calculations/memory resource situation to the second network entity. The second network entity receiving the same may add a field indicating the corresponding purpose to a header of the general data packet being transmitted or modify the field, and transfer the corresponding information together with the existing data packet to each network device through the data transmission tunnel.

When the packet having the header including the information that makes a request for reporting the in-network computing capability and current available calculations/memory resource situation, the target network device may add its own in-network computing capability and current available calculations/memory resource situation to the header and transfer the same to the next hop. For example, an identifier for identifying the target network device and information corresponding to the identifier (e.g., in-network computing capability and current available calculations/memory resource situation of the corresponding network device) may be included in the header. In every transmission to the next hop, capability and available calculations/memory resource situation of each network device may be added to the header.

A third network entity configured as an end point of the corresponding transmission tunnel or configured to serve as an end may pass through a plurality of hops to collect information included in the packet header and report the information to the first network entity.

For example, the information reported to the first network entity may include information on whether the device is a network device in a path through which application data passes while being transmitted, information on a supported function of each network device, the present status of computing resources of each network device, the present status of a memory and a storage space, a list of operations that can be performed, the number of tasks that can be performed for each operation, and/or a time point at which each operation can be performed.

For example, the third network entity making the report may be the RAN 420, a NF including the RAN, or a network device to which the corresponding role is assigned. For example, an identifier indicating the network device to which the role of reporting is assigned may be included in the information transmitted from the second network entity to the network device.

The first network entity receiving the corresponding feedback may identify available resources of network devices in the path. The first network entity may determine a target network device to perform in-network computing and determine a computing task to be performed by the corresponding network device.

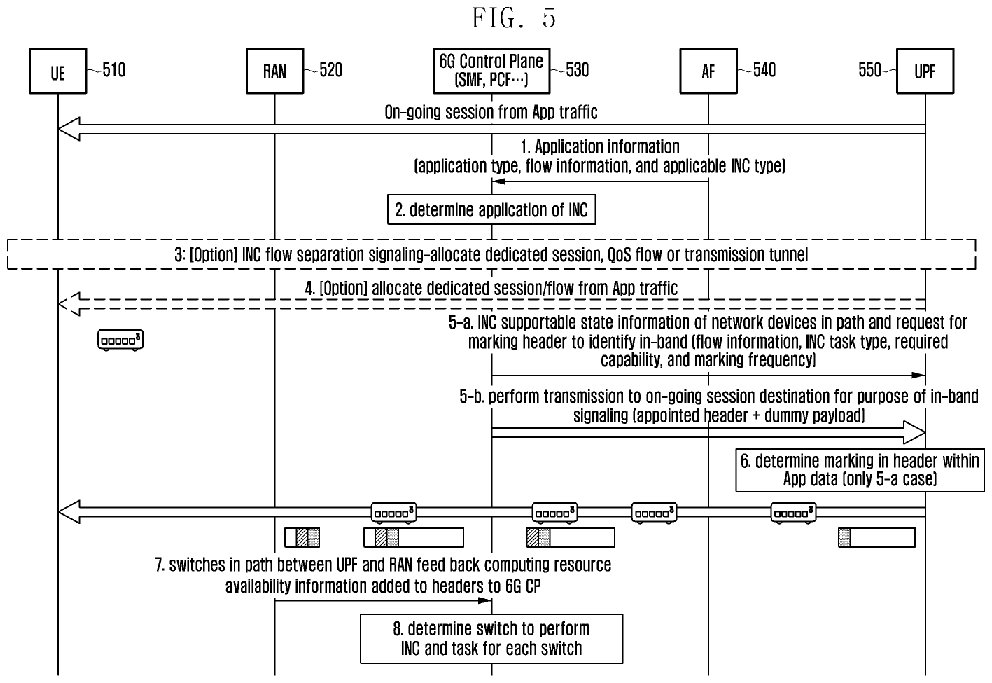

FIG. 5 illustrates an example of a signaling flowchart illustrating an in-network computing control procedure using in-band signaling according to an embodiment of the disclosure.

In FIG. 5, a 6G control plane (CP) 530 may correspond to a first network entity, a UPF 550 may correspond to a second network entity, and a RAN 520 may correspond to a third network entity.

In operation 1, the AF 540 may transmit application information to the CP 530. The application information may include an application type, flow information transferred to the application, information on an applicable INC type, or the like.

In operation 2, the CP may determine the application of the INC.

In operation 3, according to circumstances, in order to separate data flow to which the INC is applied from the existing data flow, a dedicated session, quality of service (QOS) flow, or a transmission tunnel may be allocated.

In operation 4, when the dedicated session/flow for the application of the INC or the like is allocated to the UE 510, the INC may be applied to the dedicated session/flow.

Operation 3 and operation 4 are optional operations and may not be performed according to circumstances.

In operation 5-a, in order to identify INC supportable state information of network devices in a path, the CP 530 may make a request for marking the header to identify the INC supportable state information through in-band signaling. For example, along with the request for marking the header, the marking frequency, capability required for supporting INC, an INC task type, and/or flow information to which INC is applied may be transmitted.

In operation 5-b, the CP 530 may generate a dummy data packet for the purpose of In-band signaling and transmit the same to the UPF 550. For example, the dummy data packet may be configured by a predetermined header and dummy payload indicating the purpose. The dummy data packet may include an on-going session destination information (e.g., UE address).

In operation 6, the UPF receiving the information that makes the request for marking the header in operation 5-a may determine marking indicating the corresponding purpose in the header within application data. The operation in operation 6 may be applied only when operation 5-a is performed.

The data packet marked in operation 6 or the packet received in operation 5-b may be transferred to each network device through a data transmission tunnel configured between the UPF and the RAN. The target network device may add its own in-network computing capability and current available calculations/memory resource situation into the header and transfer the same to the next hop.

In operation 7, the RAN may feed back computing resource availability information for performing INC added to the headers of network devices (e.g., switches) in the path between the UPF and the RAN to the 6G CP. For example, the information fed back to the first network entity may include information on whether the device is a network device in a path through which application data passes while being transmitted, information on a supported function of each network device, the present status of computing resources of each network device, the present status of a memory and a storage space, a list of operations that can be performed, the number of tasks that can be performed for each operation, and/or a time point at which each operation can be performed.

Based on the information, the 6G CP may identify available resources of network devices in the path.

In operation 8, the 6G CP may determine a target network device to perform INC and a task to be performed for each target device.

Through the above-described first embodiment, signaling overhead for managing the plurality of network devices in the path may be reduced. Further, the operation may be performed based on a path in which actual data flow is transmitted, and the INC operation may be supported through the NF alone of the mobile communication network without any intervention of the transport/SDN controller.

### SECOND EMBODIMENT

A second embodiment proposes a method of allocating tasks to the device determined according to the first embodiment. Accordingly, the first embodiment and the second embodiment may be combined and executed.

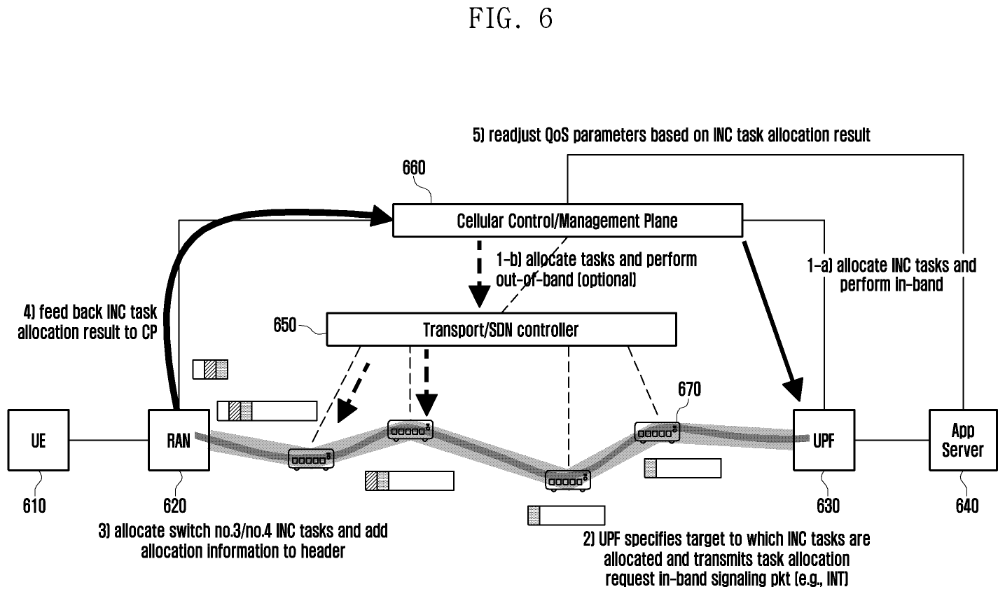

FIG. 6 illustrates an example of the operation and structure for allocating tasks to network devices in a path by using in-band signaling according to an embodiment of the disclosure.

In FIG. 6, it is basically assumed that a communication connection channel between a DN including an application server 640 and a UE is provided through a data communication path connected between a UE 610 and a RAN 620, and a UPF 630. The UPF 630 may correspond to a second network entity in a user plane. Further, it is assumed that one or more network devices 670 are located in the data communication path between the RAN and the UPF. In the following description, a path may be a data communication path between the RAN and the UPF, or a path/tunnel in which data or a data packet is transmitted.

Referring to FIG. 6, in a mobile communication system, a first network entity 660 in a control plane may allocate tasks to network devices existing in the path.

For example, the first network entity may generate a separate dummy data packet for the purpose of allocating tasks. The dummy data packet may include a UE reception address. The first network entity may transmit the generated data packet to a second network entity. The dummy data packet may be transferred to each network device through a data transmission tunnel configured between the UPF and the RAN.

In another example, the first network entity may transmit a message informing of the purpose of allocating tasks to the second network entity, and the second network entity may add a field indicating the purpose of allocating tasks into a header of a general data packet being transmitted or modify the same, and transfer the corresponding information together with the existing data packet to each network device along the data transmission tunnel.

For example, the task allocation information may include at least one of a task type to be performed by the target network device which will perform in-network computing, the number of tasks, a task performance speed, a task priority, a task completion time, or task processing-related requirements.

In the above example, it has been described that the first network entity transmits information related to task allocation to the second network entity through in-band signaling, but the information related to task allocation may be transmitted to a transport/SDN controller 650 and the transport/SDN controller 650 may transfer the information related to task allocation to each network device in the form of out-of-band signaling.

The network device receiving the packet having the header including INC task allocation information transmitted from the second network entity may identify whether itself is included in the target network device, based on the information included in the header and perform the corresponding task. Further, the network device may add the result of the task to be performed (or permitted to be performed) by itself and other information (for example, expected time required for computing) into the header and transfer the same to the next hop.

A third network entity configured as an end point of the corresponding tunnel or configured to serve as an end may pass through a plurality of hops to report information included in the packet header to the first network entity. For example, the third network entity making the report may be the RAN 620, a NF including the RAN, or a network device to which the corresponding role is assigned. For example, an identifier indicating the network device to which the role of reporting is assigned may be included in the information transmitted from the second network entity.

The first network entity receiving the corresponding feedback may recognize whether each network device accepts allocation of computing tasks, other information (for example, expected time required for computing), and the like, and readjust QoS parameters (e.g., INC computing execution time, INC computing completion time, packet delay budget, latency, jitter, reliability, required throughput, guaranteed throughput, and the like), based thereon.

Through the method of the second embodiment described above, it is possible to efficiently perform task allocation and support the task allocation operation through the NF alone of the mobile communication network without any transport/SND controller.

### THIRD EMBODIMENT

A third embodiment proposes a method of monitoring in-network computing performed by the network device according to the first embodiment and the second embodiment and optimizing an in-network computing operation, based on the monitoring. Accordingly, the first embodiment and/or the second embodiment, and the third embodiment may be combined and executed.

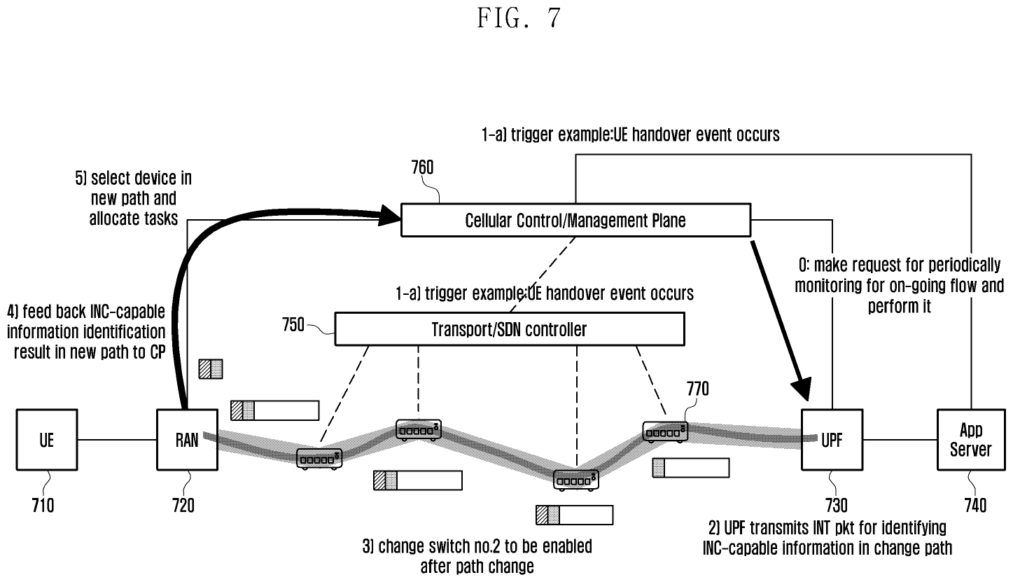

FIG. 7 illustrates an example of a process for monitoring the present status of data flow in which in-network computing is being performed using in-band signaling and optimizing an in-network computing operation, based on the monitoring according to an embodiment of the disclosure.

In FIG. 7, it is basically assumed that a communication connection tunnel between a DN including an application server 740 and a UE is provided through a data communication path connected between a UE 710 and a RAN 720, and a UPF 730. The UPF 730 may correspond to a second network entity in a user plane. Further, it is assumed that one or more network devices 770 are located in the data communication path between the RAN and the UPF. In the following description, a path may be a data communication path between the RAN and the UPF, or a path/tunnel in which data or a data packet is transmitted.

Referring to FIG. 7, in operation 0, a first network entity 760 in a control plane in a mobile communication system may monitor a status of in-network computing performed by network devices in a path, a present status of the performance of in-network computing, a traffic path, and the like. To this end, the first network entity 760 in the control plane in the mobile communication system may transmit information that indicates/makes a request for monitoring a specific network device in the path to a second network entity (e.g., the UPF).

For example, the first network entity may directly generate a separate dummy data packet for the purpose of monitoring and transmit the same to the second network entity. The dummy data packet may include a UE reception address. The dummy data packet may be transferred to each network device through a data transmission tunnel configured between the UPF and the RAN.

In another example, the first network entity may transmit a message indicating the purpose of monitoring to the second network entity. The second network entity may add a field indicating the corresponding purpose to a header of the general data packet or modify the field, and transfer the corresponding information together with the existing data packet to each network device through the data transmission tunnel.

The second network entity may transfer a packet having the header including the information that makes the request for monitoring to the network device. The network device receiving the packet having the header including the information that makes the request for monitoring and reporting the present status of in-network computing may add requested information such as a present status of the performance of a task being performed after allocated itself, a present status of resources, and the like into the header, based on information included in the header and transfer the header to the next hop.

A third network entity configured as an end point of the corresponding transmission tunnel or configured to sever as an end may pass through a plurality of hops to collect information included in the packet header and report a monitoring result to the first network entity. For example, the report may be made periodically, semi-persistently, or aperiodically.

For example, the third network entity making the report may be the RAN 720, a NF including the RAN, or a network device to which the corresponding role is assigned. For example, an identifier indicating the network device to which the role of reporting is assigned may be included in the information transmitted from the UPF.

The first network entity may recognize that an event for triggering a transmission path change in the mobile communication network or the transmission network is generated based on the received monitoring result information. Specifically, a situation where a traffic transmission path is changed may occur for the reason such as the generation of a handover or a problem in the transmission network, and when the situation is recognized based on the monitoring, an operation for changing the in-network computing target to network devices in a changed new path may be performed.

Specifically, according to the first embodiment, it is possible to identify in-network computing resources for network devices in the changed data flow path and determine a device and tasks to perform in-network computing. According to the second embodiment, it is possible to allocate the tasks to the device determined for in-network computing in the changed path. For a detailed operation, the operations of the first embodiment and the second embodiment can be referred to, and overlapping description is omitted.

Through the third embodiment, in-network computing may be controlled adaptively for various environments of the mobile communication system such as a handover, a routing path change, and the like.

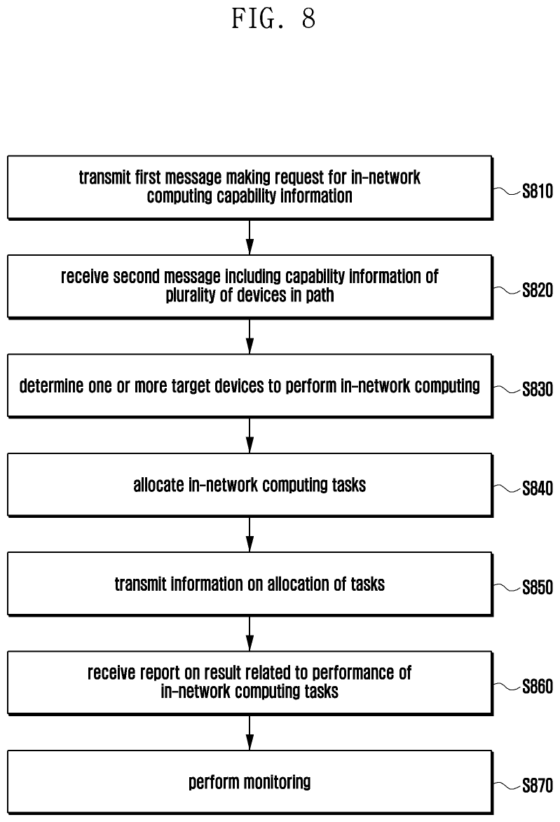

FIG. 8 illustrates an example of an operation procedure performed by a first network entity in a control plane in a mobile communication system according to an embodiment of the disclosure.

The first network entity may transmit a first message making a request for in-network computing capability information of a plurality of devices in a data transmission path to a second network entity in S810.

For example, in order to transmit the first message, the first network entity may generate a data packet including header information indicating the request for in-network computing capability information and a UE reception address and transmit the data packet to the second network entity. The data packet may be transferred to the plurality of devices through the data transmission path.

In another example, based on the first message, a data packet for the request for in-network computing capability information may be generated by the second network entity, and the data packet may be transferred to the plurality of devices through the data transmission path.

The first network entity may receive a second message including capability information of the plurality of devices from a third network entity, based on the first message in S820. For example, the second message may include computing resource information of each of the plurality of devices, a list of operations that can be performed, and information on the number of tasks that can be performed for each operation.

The first network entity may determine one or more target devices to perform in-network computing among the plurality of devices, based on the second message in S830.

The first network entity may allocate in-network computing tasks to each of the one or more target devices in S840.

The first network entity may transmit information on allocation of the in-network computing tasks in S850. For example, the information on allocation of the tasks may include at least one of a task type, a task priority, the number of tasks, or a task performance speed. Further, the information on allocation of the in-network computing tasks may be directly transmitted to the second network entity or may be transferred to the one or more target devices through a SDN controller.

The first network entity may receive a report on the result related to the performance of the in-network computing tasks of each of the one or more target devices, based on the information on allocation of the tasks in S860. For example, the report on the result related to the performance of the tasks may include information indicating whether each of the one or more target devices accepts task allocation and information on the expected time required for computing.

The first network entity may update QoS parameters, based on the report. For example, the QoS parameters may include at least one of an INC computing execution time, an INC computing completion time, a packet delay budget, latency, jitter, reliability, required throughput, or guaranteed throughput.

The first network entity may monitor the one or more target devices in S870. Specifically, in order to perform monitoring, the first network entity may generate a data packet including header information indicating monitoring and transmit the generated data packet to the second network entity. Further, information including the present status of the performance of tasks by the network device performing in-network computing and computing resource information may be received. The first network entity may determine whether to change the data transmission path, based on the received information.

Based on the monitoring, the change in the data transmission path may be detected. In this case, the first network entity may retransmit the first message making the request for in-network computing capability information of the plurality of devices in the changed path to the second network entity.

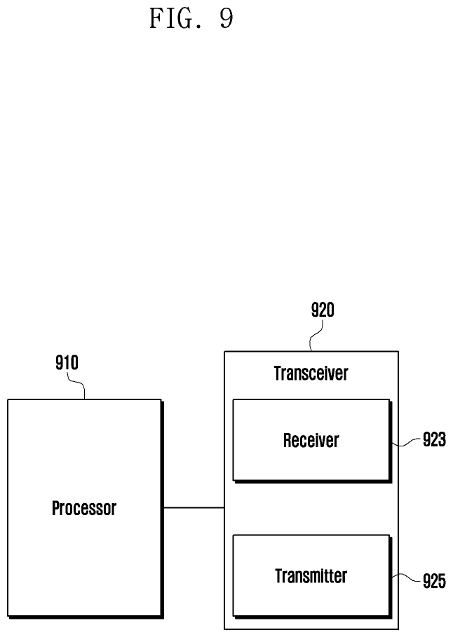

FIG. 9 is a block diagram illustrating a UE according to various embodiments of the disclosure.

Referring to FIG. 9, the UE may include a transceiver 920 and a controller 910 configured to control the overall operations of the UE. The transceiver 920 may include a transmitter 925 and a receiver 923.

The transceiver 920 may transmit and receive signals to and from other network entities (for example, RAN or BS).

The controller 910 may control the UE to perform one operation in the above-described various embodiments. The controller 910 and the transceiver 920 does not have to be implemented as separate modules but may be implemented as one component in the form of a single chip. The controller 910 and the transceiver 920 may be electrically connected. In an embodiment, the controller 910 may be a circuit, an application-specific circuit, or at least one processor. Operations of the UE may be performed as a memory device that stores the corresponding program code is included in a component (for example, the controller 910 and/or another component which is not illustrated) within the UE.

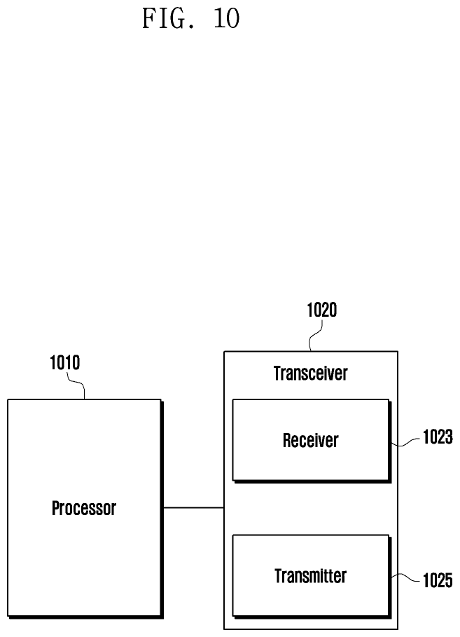

FIG. 10 is a block diagram of a network entity according to various embodiments of the disclosure. The network entity illustrated in FIG. 10 may include at least one NF (for example, a BS, a RAN, an AMF, a NSSF, a SMF, a PCF, or a UPF) according to system implementation.

Referring to FIG. 10, the network entity may include a transceiver 1020 and a controller 1010 configured to control the overall operations of the network entity. The transceiver 1020 may include a transmitter 1025 and a receiver 1023.

The transceiver 1020 may transmit and receive signals to and from the UE and other network entities. For example, the transceiver 1020 may transmit a first message making a request for in-network computing capability information of a plurality of devices in a data transmission path and receive a second message including the capability information of the plurality of devices, based on the first message.

The controller 1010 may control the network entity to perform one operation in the above-described embodiments. For example, the controller 1010 may be configured to determine one or more target devices to perform in-network computing among the plurality of devices, based on the second message and allocate in-network computing tasks to each of the one or more target devices.

The controller 1010 and the transceiver 1020 does not have to be implemented as separate modules but may be implemented as one component in the form of a single chip. The controller 1010 and the transceiver 1020 may be electrically connected. In an embodiment, the controller 1010 may be a circuit, an application-specific circuit, or at least one processor. Operations of the network entity may be performed as a memory device that stores the corresponding program code is included in a component (for example, the controller 1010 and/or another component which is not illustrated) within the network entity.

It should be noted that the above-described configuration diagrams, illustrative diagrams of control/data signal transmission methods, and illustrative diagrams of operation procedures as illustrated in FIG. 1 to FIG. 10 are not intended to limit the scope of protection of the disclosure. That is, all the constituent elements, entities, or operation steps shown and described in FIG. 1 to FIG. 10 should not be construed as being essential elements for the implementation of the disclosure, and even when including only some of the elements, the disclosure may be implemented without impairing the true of the disclosure.

The above-described operations of the embodiments may be implemented by providing any unit of a device with a memory device storing corresponding program codes. That is, a controller in the device may perform the above-described operations by reading and executing the program codes stored in the memory device by means of a processor or central processing unit (CPU).

Various units or modules of an entity or terminal device set forth herein may be operated using hardware circuits such as complementary metal oxide semiconductor-based logic circuits, firmware, or hardware circuits such as combinations of software and/or hardware and firmware and/or software embedded in a machine-readable medium. For example, various electrical structures and methods may be implemented using transistors, logic gates, and electrical circuits such as application-specific integrated circuits.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. A method performed by a first network entity in a control plane in a mobile communication system, the method comprising:
transmitting a first message making a request for in-network computing (INC) capability information of a plurality of devices in a data transmission path to a second network entity;
receiving a second message comprising capability information of the plurality of devices from a third network entity, based on the first message;
determining one or more target devices to perform in-network computing among the plurality of devices, based on the second message; and
allocating in-network computing tasks to each of the one or more target devices.

2. The method of claim 1, wherein the transmitting of the first message comprises:
generating a data packet comprising header information indicating the request for the in-network computing capability information and a reception address of a terminal; and
transmitting the data packet to the second network entity, and
wherein the data packet is transferred to the plurality of devices through the data transmission path.

3. The method of claim 1, wherein a data packet for the request for the in-network computing capability information is generated on the second network entity, based on the first message, and
wherein the data packet is transferred to the plurality of devices through the data transmission path.

4. The method of claim 1, wherein the second message comprises computing resource information of each of the plurality of devices, a list of operations that can be performed, and information on a number of tasks that can be performed for each operation.

5. The method of claim 1, further comprising:
transmitting information on allocation of the in-network computing tasks;
receiving a report on a result related to performance of the in-network computing tasks by each of the one or more target devices, based on the information on allocation of the tasks; and
updating quality of service (QOS) parameters, based on the report.

6. The method of claim 5, wherein the information on allocation of the in-network computing tasks is transmitted to the second network entity, and
wherein the information on allocation of the tasks comprises at least one of a task type, a task priority, a number of tasks, or a task performance speed.

7. The method of claim 5, the information on allocation of the in-network computing tasks is transferred to the one or more target devices through an SDN controller.

8. The method of claim 5, wherein the report on the result related to the performance of the tasks comprises information indicating whether each of the one or more target devices accepts task allocation and information on an expected time required for computing.

9. The method of claim 1, further comprising:
monitoring the one or more target devices;
detecting a change in the data transmission path; and
retransmitting the first message making a request for in-network computing capability information of a plurality of devices in a changed path to the second network entity.

10. The method of claim 9, wherein the monitoring comprises:
generating a data packet comprising header information indicating monitoring;
transmitting the generated data packet to the second network entity;
receiving information comprising a present status of performance of a task by a network device performing in-network computing and computing resource information; and
determining whether to change the data transmission path, based on the received information.

11. A first network entity in a control plane in a mobile communication system, the first network entity comprising:
a transceiver configured to transmit a first message making a request for in-network computing (INC) capability information of a plurality of devices in a data transmission path to a second network entity and receive a second message comprising capability information of the plurality of devices from a third network entity, based on the first message; and
a controller configured to determine one or more target devices to perform in-network computing among the plurality of devices, based on the second message and allocate in-network computing tasks to each of the one or more target devices.

12. The first network entity of claim 11, wherein the controller is configured to generate a data packet comprising header information indicating the request for the in-network computing capability information and a reception address of a terminal and transmit the data packet to the second network entity,
wherein the data packet is transferred to the plurality of devices through the data transmission path, and
wherein the second message comprises computing resource information of each of the plurality of devices, a list of operations that can be performed, and information on a number of tasks that can be performed for each operation.

13. The first network entity of claim 11, wherein the transceiver is further configured to transmit information on allocation of the in-network computing tasks and receive a report on a result related to performance of the in-network computing tasks by each of the one or more target devices, based on the information on allocation of the tasks, and
wherein the controller is further configured to update quality of service (QOS) parameters, based on the report.

14. The first network entity of claim 13, wherein the information on allocation of the tasks comprises at least one of a task type, a task priority, a number of tasks, or a task performance speed, and
wherein the report on the result related to the performance of the tasks comprises information indicating whether each of the one or more target devices accepts task allocation and information on an expected time required for computing.

15. The first network entity of claim 11, wherein the controller is further configured to:
monitor the one or more target devices;
detect a change in the data transmission path; and
retransmit the first message making a request for in-network computing capability information of a plurality of devices in a changed path to the second network entity.
